(19) United States
(12) Patent Application Publication
(10) Pub. No.: US 2025/0293444 A1
(43) Pub. Date: Sep. 18, 2025

(54) METHODS FOR COMPLETING ELECTRICAL CONNECTIONS BETWEEN LENS AND IMAGER PCBA FOR AUTOMOTIVE CAMERAS

(71) Applicant: Magna Electronics Inc., Auburn Hills, MI (US)

(72) Inventors: Gavin E. Skrocki, Bay City, MI (US); Matthew C. Sesti, Williamston, MI (US); Donald W. Mersino, Montrose, MI (US); Robert A. Devota, Durand, MI (US)

(21) Appl. No.: 19/077,237

(22) Filed: Mar. 12, 2025

Related U.S. Application Data
(60) Provisional application No. 63/565,076, filed on Mar. 14, 2024.

(51) Int. Cl. H01R 12/58; B23K 1/008; B23K 101/42; H04N 23/50; H04N 23/57

(52) U.S. Cl. CPC H01R 12/58; B23K 1/008; H04N 23/50; H04N 23/57; B23K 2101/42; H01R 2201/26

(57) ABSTRACT

A method for assembling a vehicular camera includes attaching a plurality of electrically conductive pins to a lens holder of the vehicular camera. The method includes guiding the plurality of electrically conductive pins of the lens holder to pass through a plurality of through-holes of a printed circuit board (PCB). The PCB has a first side and a second side separated by a thickness of the PCB. An imager is disposed at the first side of the PCB. With the plurality of electrically conductive pins of the lens holder passed through the plurality of electrically conductive through-holes, the method includes aligning the lens holder with the imager. After aligning the lens holder with the imager, the method includes securing the plurality of electrically conductive pins of the lens holder to the PCBA to electrically connect the lens holder to circuitry of the PCB.

### CROSS REFERENCE TO RELATED APPLICATION

The present application claims priority to U.S. provisional application Ser. No. 63/565,076, filed Mar. 14, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A method for assembling a vehicular camera includes attaching a plurality of electrically conductive pins to a lens holder. The lens holder accommodates a plurality of lens elements. The plurality of electrically conductive pins are electrically connected to a heating element that, when electrically powered, heats at least one lens element of the plurality of lens elements. The method includes guiding the plurality of electrically conductive pins of the lens holder to pass through a plurality of through-holes of a printed circuit board (PCB). The PCB has a first side and a second side separated by a thickness of the PCB, and an imager is disposed at the first side of the PCB. With the plurality of electrically conductive pins of the lens holder passed through the plurality of through-holes, the method includes aligning the plurality of lens elements with the imager. After aligning the plurality of lens elements with the imager, the method includes securing the plurality of electrically conductive pins of the lens holder to the PCB to electrically connect the plurality of electrically conductive pins to circuitry of the PCB.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a perspective view of a vehicular camera with conventional electrical connections between the lens assembly and a printed circuit card assembly (PCBA);

FIG. 3 is a perspective view of a vehicular camera with electrically conductive pins fixedly attached to the lens assembly; and

FIGS. 4A-4D are perspective views of vehicular cameras with a PCBA secured to the lens assembly using posts or pads.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

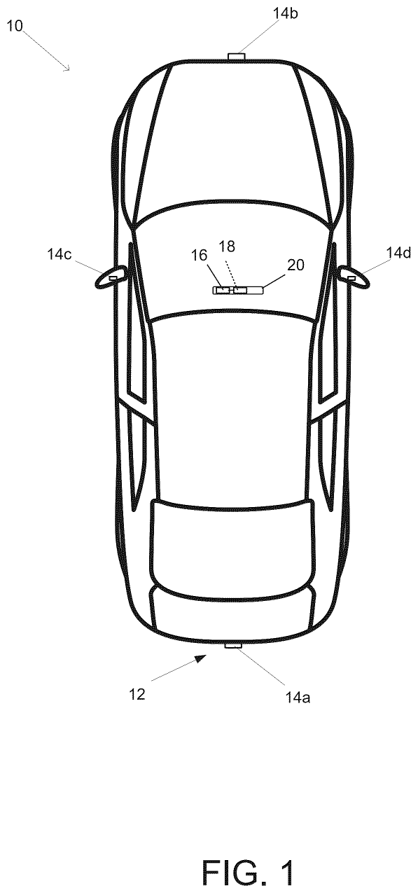

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

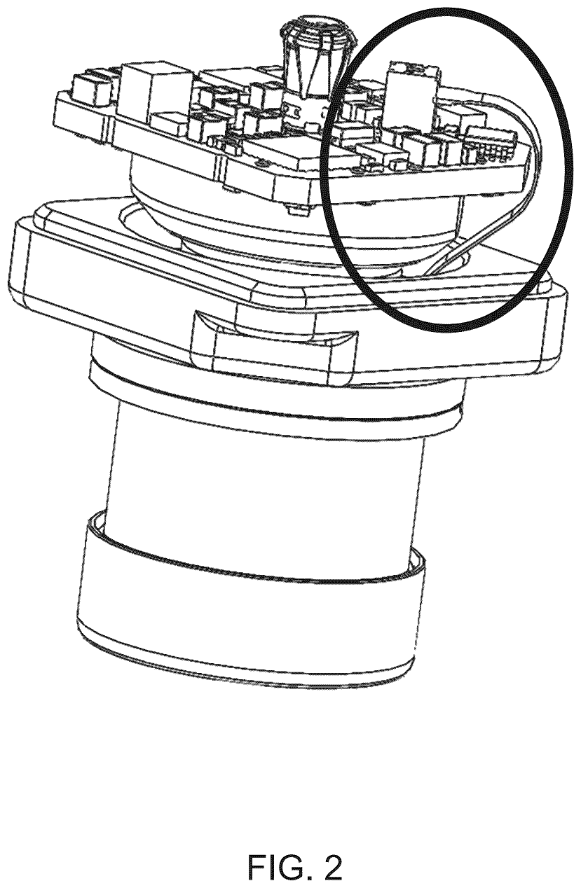

Electrical connections between the lens of a camera (e.g., the cameras 14a-d of FIG. 1) and an imager printed circuit board (PCB) or printed circuit board assembly (PCBA) of automotive cameras are becoming increasingly common. These connections are often crucial for the functionality of advanced driver-assistance systems (ADAS) and autonomous driving technologies. Such connections can be used to power and/or control lens heaters, auto focus mechanisms, sensors (e.g., thermistors), etc. For example, lens heaters can prevent fogging in cold weather, while auto focus mechanisms ensure clear image capture under various conditions. The conventional technique for these electrical connections is loose cables protruding from the back of the lens housing (FIG. 2). This method is prone to issues such as signal interference and increased wear and tear on the cables. Additionally, loose cables can complicate the assembly process and reduce the overall reliability of the camera system. However, due to the need for tighter manufacturing tolerances, no rigid connections can be made between the PCBA and lens during the active alignment process. This requirement ensures precise alignment but complicates the electrical connection process. After active alignment, the loose cables have to be inserted into expensive locking connectors or manually soldered to the PCBA. This step not only increases the cost but also introduces potential points of failure due to poor solder joints or strain on the cables. Moreover, these operations are time consuming and complicated for both human operators and robotic automation.

Implementations herein include methods and systems for eliminating the complex wire manipulation during the manufacturing process and improving reliability for vehicular cameras and other components (e.g., between the lens assembly or lens holder and the imager PCBA). This reduces capital expenditure, decreases cycle time, and increases process robustness. Additionally, these implementations increase thermal transfer and remove the need for expensive PCBA connectors along with a reduced material cost.

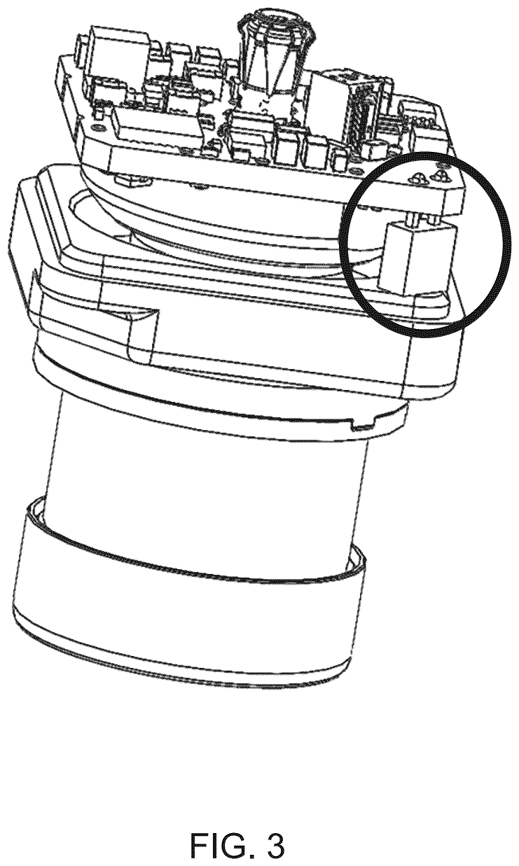

Referring now to FIG. 3, in some implementations, solder pins or any other electrically conductive pins or structures (e.g., made or plated with copper, aluminum, gold, etc.) are attached (e.g., fixedly attached) to a lens holder or lens assembly that are guided through or pass through electrically conductive through-holes on the PCBA. The lens holder may include a plurality of lens elements. These pins provide a secure and reliable electrical connection between the lens assembly and the PCBA. The pins allow for the transmission of electrical signals and/or power between the lens assembly and the PCBA. For example, the pins may electrically connect to a heating element that, when electrically powered, heats at least one lens element of the lens holder. After guiding the pins through the through-holes, the lens holder or assembly may be calibrated and/or aligned (e.g., by aligning the lens assembly with the imager). The pins and through-holes have sufficient tolerances so they do not contact during focus and alignment. That is, the through-holes may have a diameter that is a threshold amount greater than a diameter of the pins such that the difference in size between the through-holes and the pins allows the lens holder to be aligned and calibrated without the pins contacting the walls or edges of the PCBA at the through-holes. The threshold amount may be based on the amount of movement that typically or may occur during alignment and/or calibration. For example, when the pin has a diameter of 5.00 mm, the through-hole may have a diameter of 5.50 to 6 mm to ensure there is enough clearance between the surface of the pin and the surface of the through-hole to calibrate the camera. The pins may be secured (e.g., soldered) to the PCBA through-hole after the camera active alignment process.

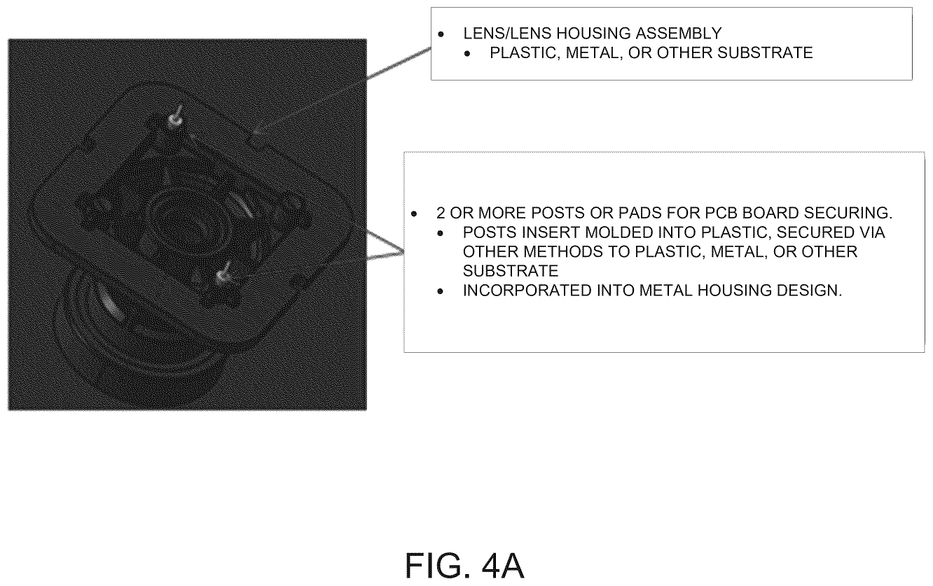

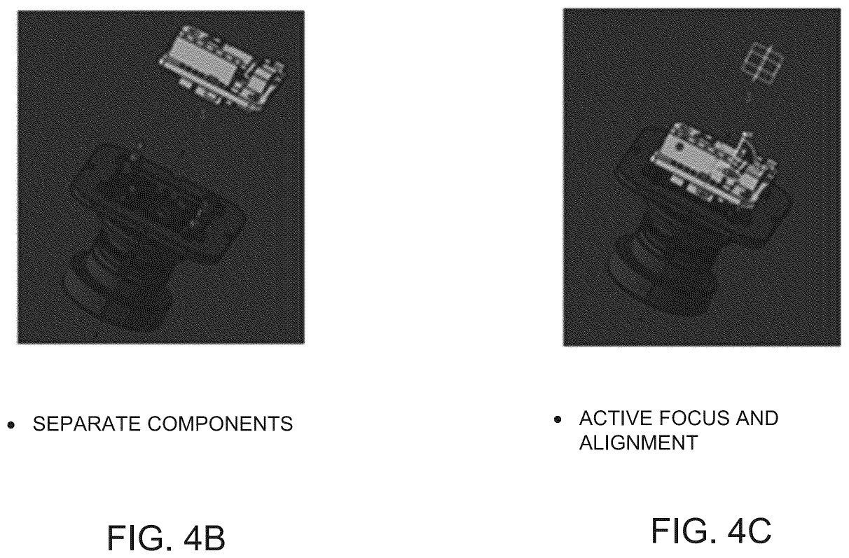

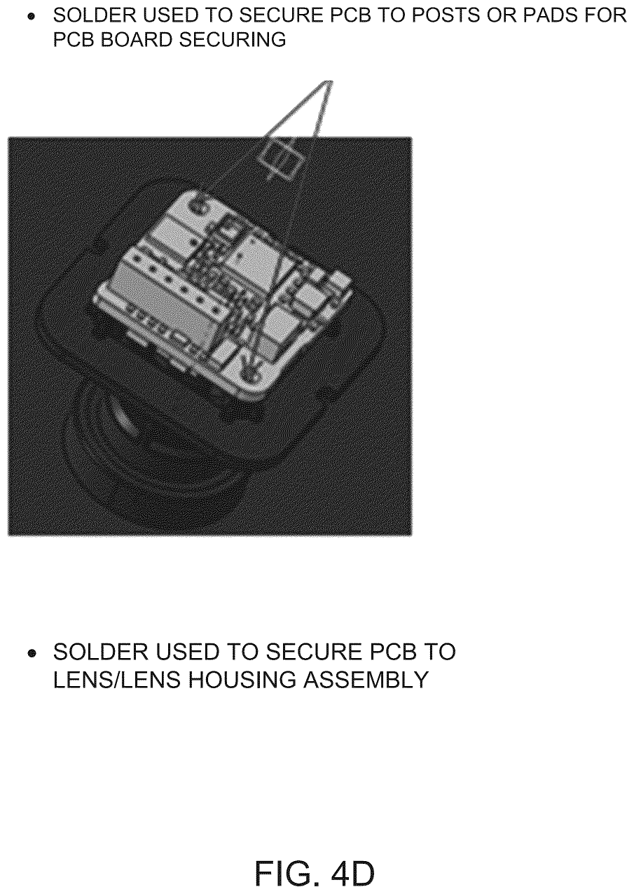

Referring now to FIGS. 4A-4D, optionally, the solder pins serve as the mechanical fixation point between the lens assembly and the PCBA assembly (such as by utilizing aspects of the camera assemblies described in U.S. Pat. Nos. 11,849,204; 11,700,439; 11,635,672 and/or 10,549,702, and/or U.S. Publication No. US-2022-0373762, which are hereby incorporated herein by reference in their entireties). One or more posts, such as posts insert molded into plastic, may be secured via various methods to plastic, metal, or other substrate to secure the lens assembly to the PCBA (FIG. 4A).

Optionally, the PCBA is set on the lens assembly for active focus and alignment (FIGS. 4B and 4C), and solder paste is dispensed over the area of the solder pin(s) and/or through-hole(s). At the end of the active alignment process, the solder paste is reflowed (FIG. 4D). This reflow process solidifies the solder, creating a strong bond between the PCBA and the lens assembly. After solder solidification, the PCBA is therefore mechanically fixed to the lens as well as electrically connected. This dual-purpose connection simplifies the assembly process and enhances the reliability of the camera system. Optionally, some solder pins may remain electrically isolated from the lens housing while other solder pins may be grounded directly to the housing. This flexibility allows for customized electrical configurations based on specific design requirements. This technique has the unique advantage of having the electrical connection process completely absorbed into a current process at no added capital investment or cycle time.

In some implementations, instead of solder paste, an electrically conductive adhesive is used to complete the electrical connection between the pins and through-holes. This adhesive could also be heat cured to allow for curing of both the optical bond adhesive and the electrically conductive adhesive simultaneously. Other connection techniques are possible, such as wire bonding, welding, and press-fit connections, as appropriate. In other implementations, instead of solder pins or electrical pins attached to the lens assembly, electrical contact pads are attached. Electrically conductive adhesive is then dispensed through the through-hole of the PCBA until it fills the gap between the lens assembly and PCBA, thereby completing the electrical connection. In yet other implementations, the electrically conductive adhesive doubles as the optical bond adhesive. The lens assembly may have a series of electrical contact pads which match electrical contact pads on the PCBA. These mirrored pads may be used for mechanical fixation of the PCBA to the image plane as well as completing electrical connections to the lens assembly. This concept has the advantage of having the electrical connection process completely absorbed into current processes at no added capital investment or cycle time.

The camera assembly or module may utilize aspects of the cameras and connectors described in U.S. Pat. Nos. 11,801,795; 11,750,905; 11,711,598; 10,272,857; 10,250,004; 10,230,875; 10,142,532; 9,621,769; 9,277,104; 9,077,098; 8,994,878; 8,542,451 and/or 7,965,336, and/or U.S. Publication Nos. US-2009-0244361; US-2013-0242099; US-2014-0373345; US-2015-0124098; US-2015-0222795; US-2015-0327398; US-2016-0243987; US-2016-0268716; US-2016-0286103; US-2016-0037028; US-2017-0129419; US-2017-0133811; US-2017-0201661; US-2017-0280034; US-2017-0295306 and/or US-2018-0098033, which are hereby incorporated herein by reference in their entireties.

The camera may include electrical connecting elements that accommodate tolerances in the housing and/or PCB mounting and/or connector portion. The electrical connecting elements may utilize aspects of the cameras and electrical connectors described in U.S. Pat. No. 9,233,641 and/or U.S. Publication Nos. US-2013-0242099; US-2014-0373345; US-2015-0222795; US-2015-0266430; US-2015-0365569; US-2016-0268716; US-2017-0133811; US-2017-0295306 and/or US-2017-0302829, which are hereby incorporated herein by reference in their entireties. Optionally, the electrical connections may be established via molded interconnect device (MID) technology, such as by utilizing aspects of the cameras described in U.S. Publication Nos. US-2018-0072239; US-2017-0295306 and/or US-2016-0037028, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

Changes and modifications in the specifically described embodiments can be carried out without departing from the principles of the invention, which is intended to be limited only by the scope of the appended claims, as interpreted according to the principles of patent law including the doctrine of equivalents.

1. A method for assembling a vehicular camera, the method comprising:
attaching a plurality of electrically conductive pins to a lens holder, wherein the lens holder accommodates a plurality of lens elements, the plurality of electrically conductive pins electrically connected to a heating element that, when electrically powered, heats at least one lens element of the plurality of lens elements;
guiding the plurality of electrically conductive pins of the lens holder to pass through a plurality of through-holes of a printed circuit board (PCB), wherein the PCB has a first side and a second side separated by a thickness of the PCB, and wherein an imager is disposed at the first side of the PCB;
with the plurality of electrically conductive pins of the lens holder passed through the plurality of through-holes, aligning the plurality of lens elements with the imager; and
after aligning the plurality of lens elements with the imager, securing the plurality of electrically conductive pins of the lens holder to the PCB to electrically connect the plurality of electrically conductive pins to circuitry of the PCB.

2. The method of claim 1, wherein securing the plurality of electrically conductive pins of the lens holder to the PCB comprises soldering the plurality of electrically conductive pins to the PCB.

3. The method of claim 1, wherein the plurality of electrically conductive pins do not contact the PCB while aligning the lens holder with the imager.

4. The method of claim 1, wherein guiding the plurality of electrically conductive pins of the lens holder to pass through the plurality of through-holes of the PCB comprises applying solder paste to at least one selected from the group consisting of (i) the plurality of electrically conductive pins and (ii) the plurality of through-holes.

5. The method of claim 4, wherein securing the plurality of electrically conductive pins of the lens holder to the PCB comprises reflowing the solder paste.

6. The method of claim 1, wherein at least one electrically conductive pin of the plurality of electrically conductive pins is electrically isolated from a housing of the lens holder.

7. The method of claim 1, wherein at least one electrically conductive pin of the plurality of electrically conductive pins is grounded to a housing of the lens holder.

8. The method of claim 1, wherein securing the plurality of electrically conductive pins of the lens holder to the PCB comprises using electrically conductive adhesive.

9. The method of claim 8, wherein the electrically conductive adhesive is heat cured.

10. The method of claim 1, wherein the plurality of electrically conductive pins comprises a copper material.

11. The method of claim 1, wherein individual electrically conductive pins of the plurality of electrically conductive pins are configured to transmit respective electrical signals for controlling the heating element of the lens holder.

12. The method of claim 1, wherein individual electrically conductive pins of the plurality of electrically conductive pins are configured to transmit electrical power between the lens holder and the PCB.

13. The method of claim 1, wherein the through-holes are plated using an electrically conductive material.

14. The method of claim 1, wherein the plurality of lens elements is accommodated in a lens barrel that is disposed at the lens holder.

15. A method for assembling a vehicular camera, the method comprising:
attaching a plurality of electrically conductive contact pads to a lens holder of the vehicular camera, wherein the lens holder accommodates a plurality of lens elements, the plurality of electrically conductive contact pads electrically connected to a heating element that, when electrically powered, heats at least one lens element of the plurality of lens elements;
disposing the lens holder at a printed circuit board (PCB) of the vehicular camera, wherein the PCB has a first side and a second side separated by a thickness of the PCB, and wherein an imager is disposed at the first side of the PCB;
dispensing electrically conductive adhesive from the plurality of electrically conductive contact pads to the PCB through a plurality of through-holes of the PCB; and
aligning the plurality of lens elements of the lens holder with the imager.

16. The method of claim 15, wherein the method further comprises, after aligning the plurality of lens elements with the imager, curing the electrically conductive adhesive to secure the lens holder relative to the PCB and to electrically connect the plurality of electrically conductive contact pads of the lens holder to circuitry of the PCB.

17. The method of claim 15, wherein the plurality of lens elements is accommodated in a lens barrel that is disposed at the lens holder.

18. The method of claim 15, wherein at least one electrically conductive contact pad of the plurality of electrically conductive contact pads is grounded to a housing of the lens holder.

19. A method for assembling a vehicular camera, the method comprising:
attaching a plurality of electrically conductive pins to a lens holder, wherein the lens holder accommodates a plurality of lens elements, the plurality of electrically conductive pins electrically connected to a heating element that, when electrically powered, heats at least one lens element of the plurality of lens elements;
guiding the plurality of electrically conductive pins of the lens holder to pass through a plurality of through-holes of a printed circuit board (PCB), wherein the through-holes are plated using an electrically conductive material, and wherein the PCB has a first side and a second side separated by a thickness of the PCB, and wherein an imager is disposed at the first side of the PCB;
with the plurality of electrically conductive pins of the lens holder passed through the plurality of through-holes, aligning the plurality of lens elements with the imager; and
after aligning the plurality of lens elements with the imager, soldering the plurality of electrically conductive pins to the PCB to electrically connect the plurality of electrically conductive pins to circuitry of the PCB.

20. The method of claim 19, wherein guiding the plurality of electrically conductive pins of the lens holder to pass through the plurality of through-holes of the PCB comprises applying solder paste to at least one selected from the group consisting of (i) the plurality of electrically conductive pins and (ii) the plurality of through-holes.

21. The method of claim 19, wherein at least one electrically conductive pin of the plurality of electrically conductive pins is electrically isolated from a housing of the lens holder.

22. The method of claim 19, wherein at least one electrically conductive pin of the plurality of electrically conductive pins is grounded to a housing of the lens holder.
